(19) United States
(12) Patent Application Publication
(10) Pub. No.: US 2022/0239106 A1
(43) Pub. Date: Jul. 28, 2022

(54) POWER ADJUSTMENT DEVICE, POWER SUPPLY-DEMAND BALANCE ADJUSTMENT SYSTEM, AND POWER SUPPLY-DEMAND BALANCE ADJUSTMENT METHOD

(71) Applicant: TOYOTA JIDOSHA KABUSHIKI KAISHA, Toyota-shi (JP)

(72) Inventor: Tomoyuki KUBOTA, Susono-shi (JP)

(73) Assignee: TOYOTA JIDOSHA KABUSHIKI KAISHA, Toyota-shi (JP)

(21) Appl. No.: 17/525,382

(22) Filed: Nov. 12, 2021

(30) Foreign Application Priority Data
Jan. 25, 2021 (JP) 2021-009736

(51) Int. Cl. H02J 3/32; H02J 3/00; H02J 7/00; B60L 58/10

(52) U.S. Cl. CPC H02J 3/322; H02J 3/003; B60L 58/10; H02J 7/00032; H02J 3/004

(57) ABSTRACT

The present power adjustment device includes: a storage device that stores vehicle information including a past behavior history of the electric vehicle participating in a VPP; and a charge-discharge instruction device for instructing the electric vehicle to charge and discharge power. The charge-discharge instruction device creates a charge-discharge plan of the electric vehicle to satisfy the power adjustment request, and instructs the electric vehicle of the created charge-discharge plan. In addition, when the charge-discharge instruction device receives an additional request of power adjustment after the instruction of the charge-discharge plan, the charge-discharge instruction device creates a change charge-discharge plan to meet the additional request, based on the estimated behavior of the electric vehicle, and the charge-discharge plan creation unit presents the electric vehicle of the charge-discharge plan that is created. The change charge-discharge plan includes information on an economic merit.

### CROSS-REFERENCE TO RELATED APPLICATION

This application claims priority to Japanese Patent Application No. 2021-009736 filed on Jan. 25, 2021, incorporated herein by reference in its entirety.

### BACKGROUND

### 1. Technical Field

The present disclosure relates to a power adjustment device of a virtual power plant that uses an electric vehicle as an energy resource, and a power supply-demand balance adjustment system and a power supply-demand balance adjustment method using such a virtual power plant.

### 2. Description of Related Art

Today, research is underway on virtual power plants (VPPs) that use a plurality of electric vehicles (including purely electric vehicles that use only batteries as energy sources, and plug-in hybrid vehicles) as energy resources. Japanese Patent No. 5905836 (JP 5905836 B) discloses an example thereof.

### SUMMARY

In a VPP using an electric vehicle, it is necessary to avoid impairing the function as a means of transportation, which is the original function of the electric vehicle. Therefore, based on the power supply-demand estimated in advance, a plan for using a battery of the electric vehicle so as to have both the function as a means of transportation and the function as an energy resource is created. However, there may be a case in which there is a gap between the estimated power supply-demand and the actual power supply-demand, and an unplanned power supply-demand balance adjustment may be necessary.

An object of the present disclosure is to make it possible to flexibly respond to an unplanned adjustment of the power supply-demand balance when a VPP using an electric vehicle as an energy resource is used for adjusting the power supply-demand balance.

In order to achieve the above object, the power adjustment device according to the present disclosure is a power adjustment device of a virtual power plant (VPP) that uses an electric vehicle as an energy resource, and includes a storage device and a charge-discharge instruction device. The storage device stores vehicle information including a past behavior history of the electric vehicle. The charge-discharge instruction device is a device that instructs an electric vehicle to charge-discharge power. When the charge-discharge instruction device receives a request of power adjustment, the charge-discharge instruction device estimates a behavior of the electric vehicle from the vehicle information, and creates a charge-discharge plan of the electric vehicle for satisfying the request of power adjustment based on the estimated behavior of the electric vehicle. The charge-discharge instruction device instructs the electric vehicle of the created charge-discharge plan. In addition, when the charge-discharge instruction device receives an additional request of power adjustment after the instruction of the charge-discharge plan, the charge-discharge instruction device creates a change charge-discharge plan to meet the additional request of power adjustment, based on the estimated behavior of the electric vehicle. The charge-discharge instruction device presents the created change charge-discharge plan to the electric vehicle. Here, the change charge-discharge plan includes information on an economic merit when the electric vehicle acts in accordance with the change charge-discharge plan and charges and discharges power.

In the power adjustment device according to the present disclosure, the change charge-discharge plan may include information on at least one of a changed charge-discharge location, a changed charge-discharge time or a changed charge-discharge amount, a changed travel route, and a changed necessary staying time.

In the power adjustment device according to the present disclosure, the charge-discharge instruction device may present the change charge-discharge plan by using a car navigation system of the electric vehicle or an information terminal held by an owner or a user of the electric vehicle.

In the power adjustment device according to the present disclosure, the charge-discharge instruction device may select a vehicle that is able to respond to a change in the charge-discharge plan based on the estimated behavior of the electric vehicle from the electric vehicle to which the charge-discharge plan is instructed, and create the change charge-discharge plan with the selected vehicle as a target.

Further, in order to achieve the above object, a power supply-demand balance adjustment system according to the present disclosure is a power supply-demand balance adjustment system using the VPP, and is configured to execute the following process. A first process is a process of creating a power adjustment plan using the VPP based on an estimation of a power supply-demand. A second process is a process of estimating a behavior of an electric vehicle from vehicle information including a past behavior history of the electric vehicle participating in the VPP. A third process is a process of creating a charge-discharge plan of the electric vehicle based on the estimated behavior of the electric vehicle and the power adjustment plan. A fourth process is a process of instructing the electric vehicle of the created charge-discharge plan. A fifth process is a process of detecting an imbalance of the power supply-demand after instructing the charge-discharge plan to the electric vehicle. A sixth process is a process of creating a change charge-discharge plan for eliminating the imbalance based on the estimated behavior of the electric vehicle, when the imbalance is detected. Then, a seventh process is a process of presenting the created change charge-discharge plan to the electric vehicle. Here, the change charge-discharge plan includes information on an economic merit when the electric vehicle acts in accordance with the change charge-discharge plan and charges and discharges power.

Further, in order to achieve the above object, a power supply-demand balance adjustment method according to the present disclosure is a power supply-demand balance adjustment method using the VPP, and is configured to execute the following steps. A first step is a step of creating a power adjustment plan using the VPP based on an estimation of a power supply-demand. A second step is a step of estimating a behavior of an electric vehicle from vehicle information including a past behavior history of the electric vehicle participating in the VPP. A third step is a step of creating a charge-discharge plan of the electric vehicle based on the estimated behavior of the electric vehicle and the power adjustment plan. A fourth step is a step of instructing the electric vehicle of the created charge-discharge plan. A fifth step is a step of detecting an imbalance of the power supply-demand after instructing the charge-discharge plan to the electric vehicle. A sixth step is a step of creating a change charge-discharge plan for eliminating the imbalance based on the estimated behavior of the electric vehicle, when the imbalance is detected. Then, a seventh step is a step of presenting the created change charge-discharge plan to the electric vehicle. Here, the change charge-discharge plan includes information on an economic merit when the electric vehicle acts in accordance with the change charge-discharge plan and charges and discharges power.

In the power adjustment device according to the present disclosure, when the charge-discharge instruction device receives an additional request of power adjustment after instruction of the charge-discharge plan, the charge-discharge instruction device creates a change charge-discharge plan to satisfy the additional request, and presents the change charge-discharge plan to the electric vehicle. The change charge-discharge plan is created based on the behavior of the electric vehicle estimated from the vehicle information including the past behavior history of the electric vehicle. Therefore, the change charge-discharge plan is easy for the owner or user of the electric vehicle to accept. The change charge-discharge plan includes information on the economic benefits of the electric vehicle acting according to the change charge-discharge plan and performing charge and discharge. Therefore, the information will be an incentive to promote the acceptance of the change charge-discharge plan by the owner or user of the electric vehicle. As a result, with the power adjustment device according to the present disclosure, it is possible to flexibly respond to an unplanned adjustment of the power supply-demand balance.

Further, in the power supply-demand balance adjustment system and method according to the present disclosure, when an imbalance between power supply and demand is detected after instruction of the charge-discharge plan to the electric vehicle, a change charge-discharge plan for eliminating the imbalance is created and the change charge-discharge plan is presented to the electric vehicle. The change charge-discharge plan is created based on the behavior of the electric vehicle estimated from the vehicle information including the past behavior history of the electric vehicle. Therefore, the change charge-discharge plan is easy for the owner or user of the electric vehicle to accept. The change charge-discharge plan includes information on the economic benefits of the electric vehicle acting according to the change charge-discharge plan and performing charge and discharge. Therefore, the information will be an incentive to promote the acceptance of the change charge-discharge plan by the owner or user of the electric vehicle. As a result, with the power supply-demand balance adjustment system and method according to the present disclosure, it is possible to flexibly respond to an unplanned adjustment of the power supply-demand balance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an overall configuration of a power supply system according to an embodiment of the present disclosure;

FIG. 2 is a block diagram showing a physical configuration of a power supply-demand balance adjustment system according to the embodiment of the present disclosure;

FIG. 3 is a block diagram showing a function of the power supply-demand balance adjustment system according to the embodiment of the present disclosure;

FIG. 4 is a flowchart showing a process flow in the power supply system according to the embodiment of the present disclosure; and

FIG. 5 is a diagram showing an outline of a matching system that connects a large-scale consumer and a VPP business operator.

### DETAILED DESCRIPTION OF EMBODIMENTS

Embodiments of the present disclosure will be described below with reference to the drawings. However, in the following embodiments, when the number, a quantity, an amount, or a range of each element, for example, is mentioned, the idea of the present disclosure is not limited to the mentioned number, etc., unless otherwise specified or except for the case where the number is obviously limited to the number mentioned in the embodiments in principle. Further, configurations, etc. that will be described in the following embodiments are not necessarily essential to the ideas according to the present disclosure, unless otherwise specified or except for the case where configurations are obviously limited to the configurations mentioned in the embodiments in principle.

1. Overall Configuration of Power Supply System

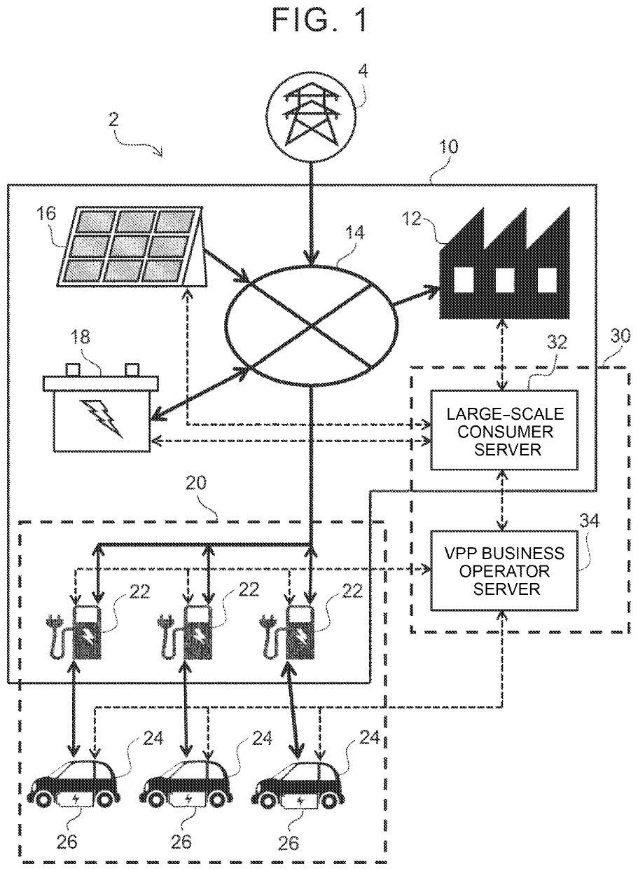

FIG. 1 is a diagram showing an overall configuration of a power supply system 2 according to an embodiment of the present disclosure. The power supply system 2 of the present embodiment is a system that supplies power to a large-scale consumer or to a large-scale consumer via an aggregator. In the following, for simplifying the description, the system in which power is supplied to the large-scale consumer via an aggregator is included in one concept of a large-scale consumer. Large-scale consumers include, for example, large-scale factory facilities and large-scale commercial facilities. It is assumed that the large-scale consumer in the present embodiment is a large-scale factory facility 12.

Large-scale consumers purchase system power from power companies, have their own power generation capacity and storage capacity, and perform operations to reduce the amount of power consumed by themselves. In a power distribution network 14 to which the large-scale factory facility 12 that is a large-scale consumer is connected, a power system 4 of a power company, a PV system 16 that generates electricity by solar power that is natural energy, and a storage battery system 18 that stores electricity are connected. The PV system 16 is one of the original power generation facilities owned by a large-scale consumer. However, since the solar energy used by the PV system 16 is natural energy that depends on weather conditions, it is difficult to completely estimate a power generation amount in advance. The storage battery system 18 is provided for the purpose of reducing a purchase power rate by storing the power generated in-house generation by the PV system 16 and using it when the system power supplied from the power system 4 is expensive. In the present embodiment, a facility 10 of a large-scale consumer includes the power distribution network 14, the PV system 16, and the storage battery system 18.

Further, a VPP (virtual power plant) 20 is connected to the power distribution network 14. However, the business operator (VPP business operator) that operates the VPP 20 is a business operator different from the large-scale consumer. The VPP 20 of the present embodiment is a VPP that uses a plurality of electric vehicles 24 as energy resources. An electric vehicle 24 used in the VPP 20 includes a pure electric vehicle (EV) and a plug-in hybrid vehicle (PHV). The EV is an electric vehicle that runs on an electric motor using only a battery 26 as an energy source. The PHV is an electric vehicle that has an electric motor and an internal combustion engine, and that can directly charge the battery 26, which is an energy source of the electric motor, from the outside. The electric vehicle 24 may be a single type of electric vehicle or a mixture of a plurality of types of electric vehicles. The types of electric vehicles include not only the difference between EV and PHV, but also the difference in the capacity of the battery 26.

In the VPP 20, a plurality of charge-discharge stands 22 connected to the power distribution network 14 is prepared. The electric vehicle 24 that is an energy resource of the VPP 2 is connected to the power distribution network 14 via the charge-discharge stand 22. The charge-discharge stand 22 is used to charge the battery 26 of the electric vehicle 24 from the power distribution network 14 and discharge the battery 26 of the electric vehicle 24 to the power distribution network 14. However, not all electric vehicles can be connected to the power distribution network 14. The electric vehicle that can be connected to the power distribution network 14 is limited to the electric vehicle 24 that participates in the VPP 20. Hereinafter, unless otherwise specified, the electric vehicle 24 means an electric vehicle participating in the VPP 20. The place where the charge-discharge stand 22 is installed is not limited, but in the present embodiment, it is assumed that the charge-discharge stand 22 is installed in the facility 10 of a large-scale consumer. However, the charge-discharge stand 22 may be prepared by a large-scale consumer or may be prepared by a VPP business operator.

The power supply system 2 of the present embodiment includes a power supply-demand balance adjustment system 30 that adjusts the balance between the power consumed by the large-scale factory facility 12 and the power supplied to the large-scale factory facility 12. The power supply-demand balance adjustment system 30 includes a large-scale consumer server 32 operated by a large-scale consumer and a VPP business operator server 34 operated by a VPP business operator. The large-scale consumer server 32 and the VPP business operator server 34 are connected by a communication network including the Internet.

The large-scale consumer server 32 is, for example, a factory energy management system (FEMS) that is an energy management system for a large-scale factory facility. The large-scale consumer server 32 monitors the power distribution network 14, estimations supply and demand, and requests that the VPP business operator server 34 described later to adjust the amount of power.

The VPP business operator server 34 is a power adjustment device that adjusts the supply and demand of power between the VPP 20 and the power distribution network by adjusting the charge-discharge power of the electric vehicle 24 participating in the VPP 20. The charge-discharge power adjustment by the VPP business operator server 34 is performed based on the power adjustment request from the large-scale consumer server 32. Specifically, when the supply of insufficient power is requested from the large-scale consumer server 32, the VPP business operator server 34 adjusts the charge-discharge power of each electric vehicle 24 so that the amount of power requested is discharged from the electric vehicle 24 to the power distribution network 14. When the large-scale consumer server 32 stores the surplus power, the VPP business operator server 34 adjusts the charge-discharge power of each electric vehicle 24 so that the required amount of power is charged from the power distribution network 14 to the electric vehicle 24.

The VPP business operator server 34 instructs each electric vehicle 24 of a charge-discharge plan, and transmits control data to the charge-discharge stand 22 that is under the control of the VPP business operator server 34. The charge-discharge plan is instructed by mobile communication such as 4G or 5G. The control data is transmitted via a communication network including the Internet. The electric vehicle 24 instructed to perform the charge-discharge plan is connected to the charge-discharge stand 22, and the charge-discharge is performed between the charge-discharge stand 22 and the electric vehicle 24 in accordance with the control data so as to adjust the charge-discharge power of each electric vehicle 24. The creation of the charge-discharge plan will be described later.

Another function of the VPP business operator server 34 is a function of managing vehicle information of each electric vehicle 24 participating in the VPP 20. The vehicle information includes the past action history of each electric vehicle 24. Further, the vehicle information includes a vehicle ID for identifying each electric vehicle 24, a current position of each electric vehicle 24, a traveling distance of each electric vehicle 24, a charging state (SOC) and a deterioration state of the battery 26 of each electric vehicle 24, and the like. The VPP business operator server 34 individually extracts vehicle information from each electric vehicle 24 by mobile communication, and updates the stored vehicle information of each electric vehicle 24 to the latest information. The VPP business operator server 34 stores vehicle information of all the electric vehicles 24 participating in the VPP 20, that is, vehicle big data.

2. Configuration of Power Supply-Demand Balance Adjustment System

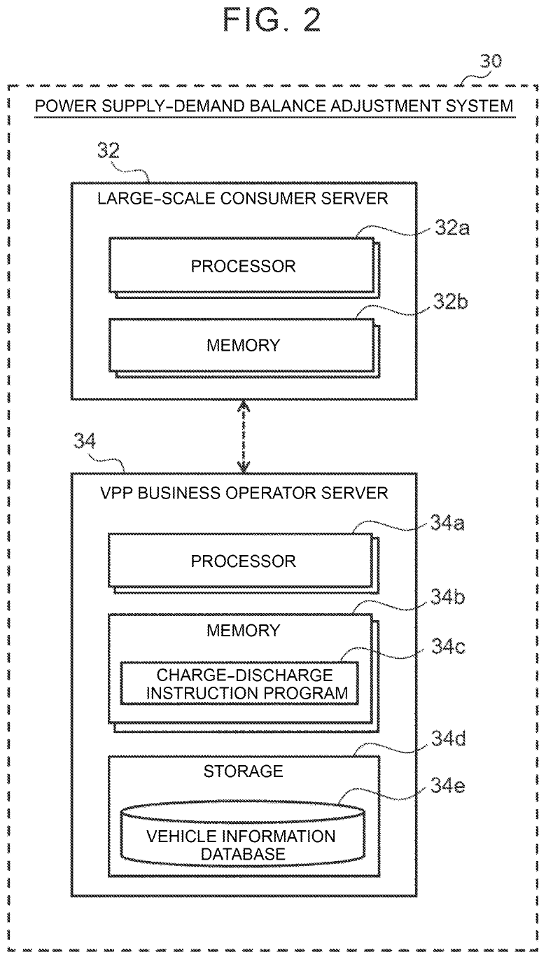

Next, a configuration of the power supply-demand balance adjustment system 30 will be described. FIG. 2 is a block diagram showing the physical configuration of the power supply-demand balance adjustment system 30, specifically, the physical configurations of the large-scale consumer server 32 and the VPP business operator server 34.

The large-scale consumer server 32 includes one or a plurality of processors 32a (hereinafter, simply referred to as a processor 32a) and one or a plurality of memories 32b (hereinafter, simply referred to as a memory 32b) coupled to the processor 32a. The memory 32b stores a program that can be executed by the processor 32a and various information related thereto. When the processor 32a executes the program, various processes by the processor 32a are realized. Further, the function of the large-scale consumer server 32 as a FEMS is also realized by executing one or a plurality of programs by the processor 32a.

The VPP business operator server 34 includes one or more processors 34a (hereinafter, simply referred to as a processor 34a) and one or more memories 34b (hereinafter, simply referred to as a memory 34b) coupled to the processor 34a. The memory 34b stores a program that can be executed by the processor 34a and various information related thereto. When the processor 34a executes the program, various processes by the processor 34a are realized. The charge-discharge instruction program 34c is one of the programs stored in the memory 34b. When the charge-discharge instruction program 34c is executed, the processor 34a functions as a charge-discharge instruction device. Further, the VPP business operator server 34 includes a storage 34d. A vehicle information database 34e is stored in the storage 34d. The vehicle information database 34e is a database that manages vehicle information (vehicle big data) of each electric vehicle 24.

3. Function of Power Supply-Demand Balance Adjustment System

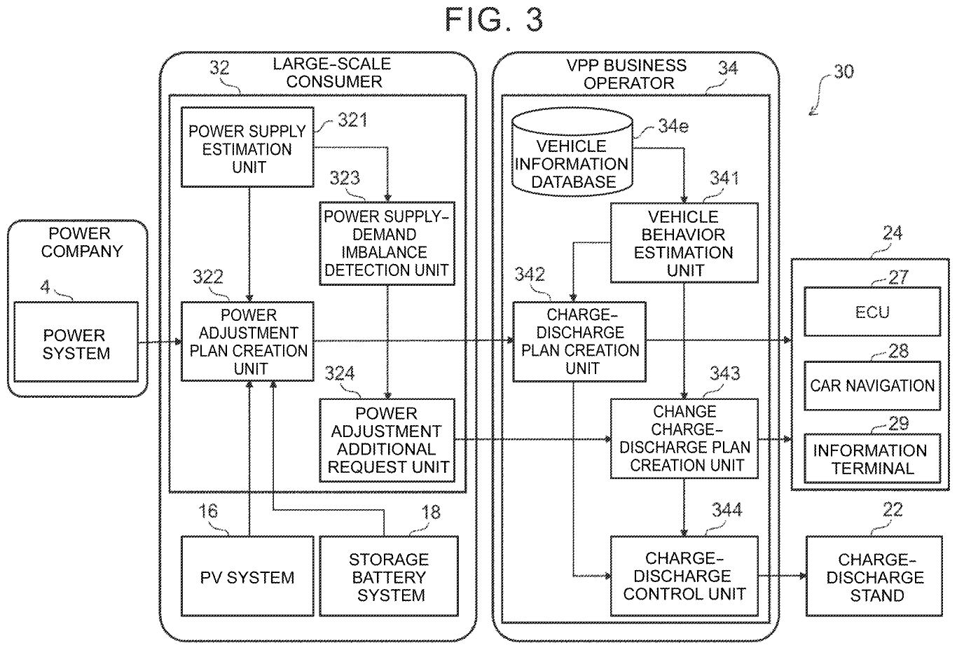

Next, the function of the power supply-demand balance adjustment system 30 will be described. FIG. 3 is a block diagram showing the function of the power supply-demand balance adjustment system 30, specifically, the functions of the large-scale consumer server 32 and the VPP business operator server 34.

The large-scale consumer server 32 includes a power supply-demand estimation unit 321, a power adjustment plan creation unit 322, a power supply-demand imbalance detection unit 323, and a power adjustment additional request unit 324. These are realized as a function of the large-scale consumer server 32 when the program stored in the memory 32b is executed by the processor 32a.

The power supply-demand estimation unit 321 predicts the power supply and demand from the viewpoint of effectively utilizing the PV system 16 and the storage battery system 18 that are its own facilities in order to minimize the purchased power of the system power from the power system 4. The power supply-demand to be estimated is the power supply-demand after tomorrow, at least including tomorrow's power supply-demand. Regarding the power supply, the amount of power of solar generated power by the PV system 16 is estimated mainly from the weather information. Regarding the demand, the demand for power consumed for the air conditioning of the large-scale factory facility 12 can be considered. However, this also has many factors that depend on the weather. Therefore, much of the electricity supply and demand estimation is occupied by weather estimations.

The power adjustment plan creation unit 322 acquires information on the operating state of the equipment from the PV system 16, acquires information on the storage state from the storage battery system 18, and acquires the power supply-demand estimation from the power supply-demand estimation unit 321. The power adjustment plan creation unit 322 creates a power adjustment plan using the VPP 20 based on the acquired information. The power adjustment plan created by the power adjustment plan creation unit 322 is a power adjustment plan that will be required tomorrow. Generally, since the electricity bill is set high during the time period when the power demand is large, the power adjustment plan creation unit 322 creates a plan so that the purchase of system power from the power system 4 during that time period is reduced. The power adjustment plan creation unit 322 transmits the created power adjustment plan to the VPP business operator server 34.

The power supply-demand imbalance detection unit 323 detects the power supply-demand imbalance in the power supply system 2. Specifically, the power supply-demand imbalance detection unit 323 detects deviation of the actual power supply-demand from the power adjustment plan created the previous day. If the actual power supply-demand is in line with the power adjustment plan, the power supply-demand as planned is realized. However, if there is a deviation, there is an imbalance in the supply and demand of electricity according to the degree of the deviation. A major factor in the deviation between the plan and the actual results is the event related to the weather. Therefore, when the imbalance of power supply-demand is detected, the power supply-demand imbalance detection unit 323 calculates the shortage of power adjustment assumed from the deviation between the weather estimation of the previous day and the weather of the present day.

The power adjustment additional request unit 324 transmits an urgent additional request of power adjustment to the VPP business operator server 34 based on the shortage of the power adjustment power calculated by the power supply-demand imbalance detection unit 323. An urgent additional request is, for example, a request that must be met within a few hours, if not immediately. When the shortage of power adjustment is the shortage of power supply, the options that can be taken are basically either to increase the purchase amount of system power from the power system 4 or to procure power from the VPP 20. The power adjustment additional request unit 324 selects a cheaper procurement source in consideration of the power procurement costs of both parties. When procuring the power from the VPP 20 is selected, the power adjustment additional request unit 324 requests the VPP business operator server 34 to supply the power from the VPP 20. However, when the insufficient power adjustment is a surplus power, the power adjustment additional request unit 324 requests the VPP business operator server 34 to take over the surplus power with the VPP 20.

The VPP business operator server 34 includes a vehicle behavior estimation unit 341, a charge-discharge plan creation unit 342, a change charge-discharge plan creation unit 343, and a charge-discharge control unit 344. These are realized as a function of the VPP business operator server 34 when the program stored in the memory 34b is executed by the processor 34a. Further, as described above, the VPP business operator server 34 includes the vehicle information database 34e that manages vehicle information of each electric vehicle 24.

The vehicle behavior estimation unit 341 acquires the latest vehicle information, more specifically, the vehicle big data from the vehicle information database 34e, and predicts the behavior of each electric vehicle 24 based on the vehicle big data. Specifically, a behavior estimation model acquired by machine learning including deep learning is used to predict vehicle behavior. The estimated vehicle behavior is, in detail, the behavior regarding how the vehicle is used, that is, the usage time zone, usage location, and travel route.

The charge-discharge plan creation unit 342 creates a charge-discharge plan for each electric vehicle 24 for satisfying the power adjustment plan based on the power adjustment plan acquired from the large-scale consumer server 32 and the vehicle behavior estimated by the vehicle behavior estimation unit 341. The charge-discharge plan creation unit 342 creates a charge-discharge plan that is optimized so as to achieve both maximization of electric revenue and minimization of deterioration of the battery 26 within a range that does not lose the original purpose of the vehicle regarding the movement of the electric vehicle 24.

The charge-discharge plan creation unit 342 instructs the electric vehicle 24 of the created charge-discharge plan. The charge-discharge plan creation unit 342 may instruct the electric vehicle 24 of the charge-discharge plan to the car navigation system 28, or to the information terminal 29 owned by the owner or user of the electric vehicle 24. Alternatively, if it is determined by a contract, for example, to follow the instructed charge-discharge plan, the charge-discharge plan may be instructed to the electronic control unit (ECU) 27 that controls the electric vehicle 24.

After the instruction of the charge-discharge plan to the electric vehicle 24, when the change charge-discharge plan creation unit 343 receives an urgent additional request of power adjustment from the large-scale consumer server 32, the change charge-discharge plan creation unit 343 creates a change charge-discharge plan to satisfy the additional request. The change charge-discharge plan is a proposed modification to the previously created charge-discharge plan. For example, a charge-discharge location and time that can be handled without limiting the use of the electric vehicle 24 are proposed as a modification. The change charge-discharge plan creation unit 343 creates a change charge-discharge plan that is easy for the electric vehicle 24 to handle, based on the vehicle behavior estimated by the vehicle behavior estimation unit 341. Further, regarding the change of the charge-discharge plan, both the case of charging and the case of discharging (power supply) when viewed from the electric vehicle 24 side are assumed. In addition, the change of the charge-discharge plan is targeted at the electric vehicle 24 in which the SOC can be adjusted within a range that does not affect the vehicle use from the next time onward.

The change charge-discharge plan contains information about the change charge-discharge location, charge-discharge time, and charge-discharge amount. In addition, information on the travel route when the change is accepted and information on the required staying time at each facility may be included. In addition, if a sufficient SOC is secured for the planned travel but the SOC changes due to changes in the charge-discharge plan, information on the impact on the next initial vehicle use may be included.

The change charge-discharge plan includes information on the economic benefits of the electric vehicle 24 acting according to the change charge-discharge plan and performing charge-discharge. The economic merit means the profit acquired by the owner or user of the electric vehicle 24 (hereinafter, the electric vehicle 24 may mean the owner or user) by buying and selling electricity. The urgent additional request of power adjustment transmitted from the large-scale consumer server 32 to the VPP business operator server 34 includes information on a selling price of power when the additional request is met. Based on this information, information about the economic benefits included in the change charge-discharge plan is generated.

Specifically, when discharge is required in the change charge-discharge plan, the power in the battery 26 will be sold to a large-scale consumer, from the electric vehicle 24. If the selling price at this time is higher than the self-consumption of power or the selling price of when the power is sold directly, it is an advantage for the electric vehicle 24 to respond to the plan change. Further, when charging is required in the change charge-discharge plan, the electric vehicle 24 purchases power from the large-scale consumer. If the purchase price at this time is lower than the purchase price when the system power is purchased (charged) from the power system 4, the electric vehicle 24 has a merit of responding to the plan change.

The change charge-discharge plan creation unit 343 presents the created change charge-discharge plan to the electric vehicle 24. The change charge-discharge plan creation unit 343 may present the charge-discharge plan to the electric vehicle 24 to the car navigation system 28, or to the information terminal 29 owned by the owner or user of the electric vehicle 24. The change charge-discharge plan creation unit 343 requests the electric vehicle 24 to reply to whether the change charge-discharge plan can be supported in the presentation to the electric vehicle 24.

The charge-discharge control unit 344 transmits the control data for each electric vehicle 24 created in accordance with the charge-discharge plan to the charge-discharge stand 22. When the electric vehicle 24 is connected to the charge-discharge stand 22 and the charge-discharge stand 22 operates according to the control data, charging and discharging is performed in the electric vehicle 24 in accordance with the charge-discharge plan. When the change charge-discharge plan is created, the charge-discharge control unit 344 transmits the change control data of the electric vehicle 24 that has accepted the change charge-discharge plan to the charge-discharge stand 22. When the electric vehicle 24 that has accepted the change charge-discharge plan is connected to the charge-discharge stand 22 and the charge-discharge stand 22 operates according to the change control data, charging and discharging is performed in the electric vehicle 24 in accordance with the change charge-discharge plan.

4. Process Flow in the Power Supply System

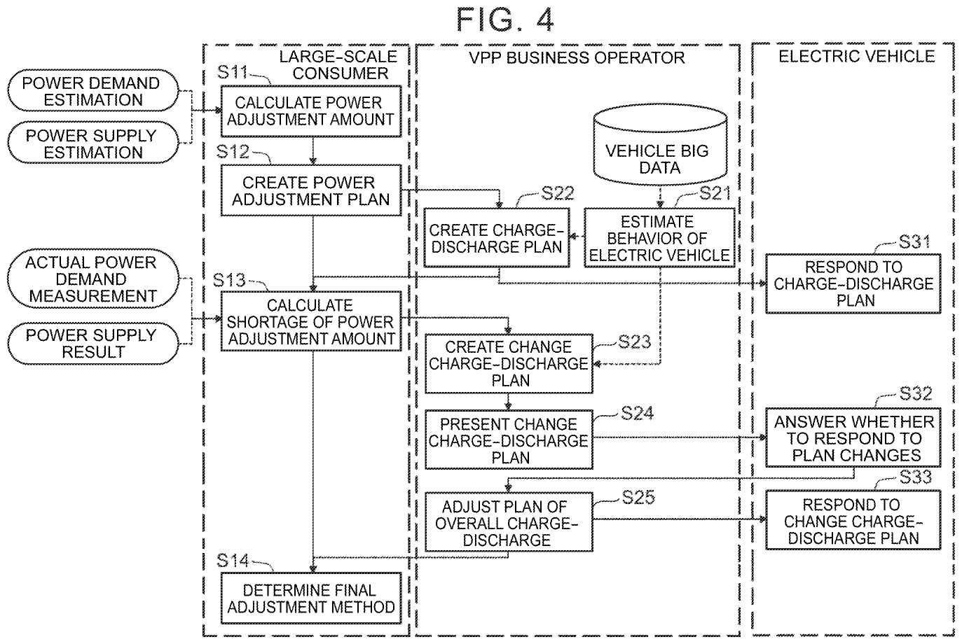

Next, the process flow in the power supply system 2 will be described. FIG. 4 is a flowchart showing the flow of process in the power supply system 2 separately for a process performed by the large-scale consumer, a process performed by the VPP business operator, and a process performed by the electric vehicle. The main process entity in the large-scale consumer is the large-scale consumer server 32, and the main process entity in the VPP business operator is the VPP business operator server 34. The main process entity in the electric vehicle is the electric vehicle 24 or its owner or user.

According to the flowchart shown in FIG. 4, first, in the large-scale consumer, the power adjustment amount is calculated based on the power demand estimation and the power supply estimation (step S11). Next, the power adjustment plan is created based on the power adjustment amount calculated in step S11 (step S12). The prepared power adjustment plan is sent to the VPP business operator.

The VPP business operator predicts the behavior of the electric vehicle 24 using the behavior estimation model acquired by machine learning using the vehicle big data (step S21). Then, a charge-discharge plan for each electric vehicle 24 is created based on the power adjustment plan created in the large-scale consumer and the behavior of the electric vehicle 24 estimated in step S21 (step S22). The created charge-discharge plan is instructed to the electric vehicle 24 and sent to a large-scale consumer.

In the electric vehicle 24, if there is no inconvenience in the charge-discharge plan instructed by the VPP business operator, the charge and discharge is performed in accordance with the charge-discharge plan (above, step S31).

After the charge-discharge plan is instructed to the electric vehicle 24, in the large-scale consumer, the actual power demand and the power supply result are acquired, and the shortage of the power adjustment amount based on the difference between the actual power supply-demand with respect to the power adjustment plan is calculated (step S13). An urgent additional request of power adjustment based on the shortage of the power adjustment amount is send from the large-scale consumer to VPP business operators.

The VPP business operator creates a change charge-discharge plan based on the urgent additional request of power adjustment from the large-scale consumer and the behavior of the electric vehicle 24 estimated in step S21 (step S23). The change charge-discharge plan is created for only the vehicle that can respond to the change in the charge-discharge plan among the electric vehicles 24. The created change charge-discharge plan is presented to the target electric vehicle 24 (step S24).

When the car navigation system 28 is used to present the change charge-discharge plan, if the vehicle is running, the change charge-discharge plan is presented immediately at the timing when the change charge-discharge plan is created. When the vehicle is unused, when the IG is turned on, if the timing is the timing that the vehicle can respond to the plan change, the presentation is performed at that timing. That is, not only the traveling vehicle but also the vehicle determined to be able to respond to the change charge-discharge plan is presented even before the start of traveling. For example, if there is a vehicle that departs 30 minutes later, and if the vehicle is scheduled to pass near an area that requires power adjustment after 1 hour, the vehicle will be notified even before departure. By performing such an operation, it becomes possible to make more vehicles respond to the change charge-discharge plan. When the information terminal 29 such as a smartphone is used for presenting the change charge-discharge plan, the change charge-discharge plan is immediately presented at the timing when the change charge-discharge plan is created, regardless of the state of the vehicle.

Further, when the car navigation system 28 is used, it is possible to acquire the position information of the vehicle in real time. By using geo-fencing technology based on vehicle position information, it is possible to present the change charge-discharge plan to the electric vehicle 24 that has entered the vicinity area of the target area that requires an urgent power adjustment. Further, by operating together with the car navigation system, the electric vehicle 24 can be quickly guided to the target charge-discharge stand 22.

Regardless of whether the car navigation system 28 or the information terminal 29 is used, the change charge-discharge plan is displayed in the HMI and the acceptance or rejection input is prepared. When the information terminal 29 is used, if there is spare time between the presentation of the change charge-discharge plan and the actual use of the electric vehicle 24, it becomes possible to fully consider whether the change charge-discharge plan is accepted.

When the owner or user of the electric vehicle 24 inputs an answer on the system, the answer to the VPP business operator is notified (step S32). The change charge-discharge plan includes information on the economic benefits of the electric vehicle 24 acting according to the change charge-discharge plan and performing charge and discharge. One of the main reasons why the owner or user of the electric vehicle 24 participates in the VPP 20 is the economic merit. Therefore, it is expected that the information on the economic merit will be an incentive to promote the acceptance of the change charge-discharge plan by the owner or user of the electric vehicle 24.

The VPP business operator adjusts the overall charge-discharge plan based on the acceptance or rejection response to the change charge-discharge plan acquired from the electric vehicle 24 (step S25). That is, in accordance with the acceptance status of the change charge-discharge plan for each electric vehicle 24, the charge-discharge plan for satisfying the urgent additional request of power adjustment from the large-scale consumer is reviewed as a whole, and the final change charge discharge plan is notified to each electric vehicle 24. The final charge-discharge plan adjustment result is sent to the large-scale consumer.

For the large-scale consumer, the final adjustment method is determined based on the adjustment result of the charge-discharge plan by the VPP business operator (step S14). By eliminating the shortage of the power adjustment amount by the power adjustment by the VPP business operator, the large-scale consumer does not need to purchase the shortage power from the power system 4 or does not need to throw away the surplus power.

5. Matching System of Large-scale Consumer and VPP Business Operator

In the explanation so far, it is assumed that there is a one-to-one relationship between the large-scale consumer and the VPP business operator. However, when there are multiple large-scale consumers in a specific area, and considering that the major factor that causes the supply and demand estimation to deviate from the actual supply and demand is the weather condition, it is assumed that consumers will need additional power adjustments at the same time when the estimation also deviates for multiple adjacent consumers in the same way. In addition, if there is a charge-discharge stand in the facility of the large-scale consumer, the electric vehicle can charge-discharge at the designated time zone. Thus, considering the characteristic of the electric vehicle that it can be moved, the number of options of the vehicle that can respond is increased. In other words, depending on the situation, it is assumed that multiple VPP business operators will be able to handle additional power adjustments.

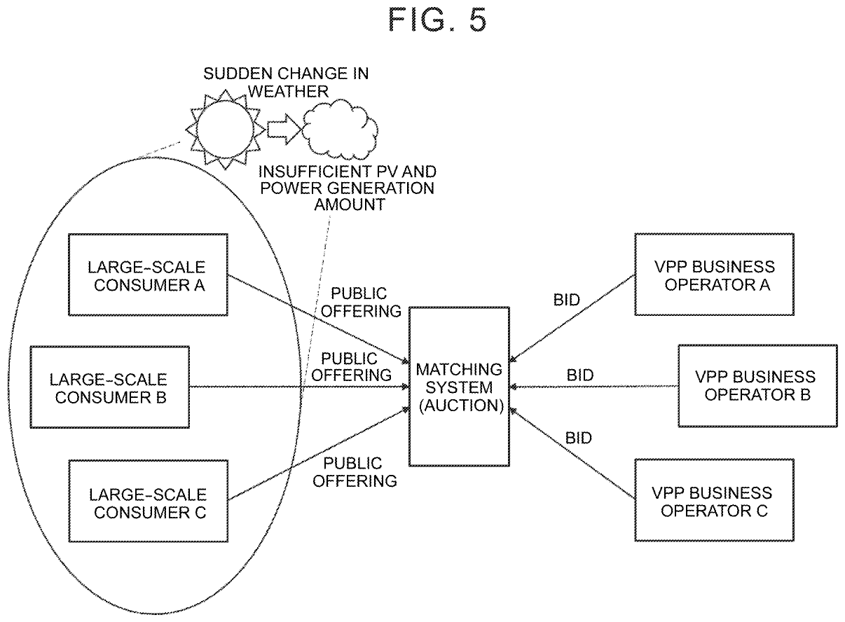

From the above, it is assumed that the relationship between the large-scale consumer and the VPP business operator is not only a one-to-one combination but also a one-to-many, many-to-one, or a many-to-many combination. In that case, the large-scale consumer wants to select the VPP business operator from which power can be procured at a lower cost. In contrast, there is a request from the VPP business operator to select the large-scale consumer who will buy power at a higher price. As a means for satisfying such a demand, a system for determining matching by bidding using an auction format is preferable. FIG. 5 is a diagram showing an outline of an auction-type matching system that connects the large-scale consumer and the VPP business operator. The power supply-demand balance adjustment system 30 described above can also be applied to a combination of the large-scale consumer and the VPP business operator combined by such a matching system.

What is claimed is:

1. A power adjustment device of a virtual power plant that uses an electric vehicle as an energy resource, the power adjustment device comprising:
a storage device that stores vehicle information including a past behavior history of the electric vehicle; and
a charge-discharge instruction device for instructing the electric vehicle to charge and discharge power,
wherein when the charge-discharge instruction device receives a request of power adjustment, the charge-discharge instruction device executes
estimation of a behavior of the electric vehicle from the vehicle information, and creation of a charge-discharge plan of the electric vehicle for satisfying the request of power adjustment based on the estimated behavior of the electric vehicle, and
instruction of the charge-discharge plan that is created to the electric vehicle, and
wherein when the charge-discharge instruction device receives an additional request of power adjustment after the charge-discharge plan is instructed, the charge-discharge instruction device executes
creation of a change charge-discharge plan to meet the additional request of power adjustment, based on the estimated behavior of the electric vehicle, and
presentation of the change charge-discharge plan that is created to the electric vehicle, and
wherein the change charge-discharge plan includes information on an economic merit when the electric vehicle acts in accordance with the change charge-discharge plan and charges and discharges power.

2. The power adjustment device according to claim 1, wherein the change charge-discharge plan includes information on at least one of a changed charge-discharge location, a changed charge-discharge time or a changed charge-discharge amount, a changed travel route, and a changed necessary staying time.

3. The power adjustment device according to claim 1, wherein the charge-discharge instruction device presents the change charge-discharge plan by using a car navigation system of the electric vehicle or an information terminal held by an owner or a user of the electric vehicle.

4. The power adjustment device according to claim 1, wherein the charge-discharge instruction device selects a vehicle that is able to respond to a change in the charge-discharge plan based on the estimated behavior of the electric vehicle from the electric vehicle to which the charge-discharge plan is instructed, and creates the change charge-discharge plan with the selected vehicle as a target.

5. An adjustment system of a power supply-demand balance that uses a virtual power plant,
wherein the adjustment system is configured to:
create a power adjustment plan using the virtual power plant based on an estimation of a power supply-demand;
estimate behavior of an electric vehicle from vehicle information including a past behavior history of the electric vehicle participating in the virtual power plant;
creating a charge-discharge plan of the electric vehicle based on the estimated behavior of the electric vehicle and the power adjustment plan;
instruct the electric vehicle of the charge-discharge plan that is created;
detect an imbalance of the power supply-demand after instructing the charge-discharge plan to the electric vehicle;
create a change charge-discharge plan for eliminating the imbalance based on the estimated behavior of the electric vehicle, when the imbalance is detected; and
present the change charge-discharge plan that is created to the electric vehicle, and
wherein the change charge-discharge plan includes information on an economic merit when the electric vehicle acts in accordance with the change charge-discharge plan and charges and discharges power.

6. An adjustment method of a power supply-demand balance that uses a virtual power plant, the adjustment method comprising:
a step of creating a power adjustment plan using the virtual power plant based on an estimation of a power supply-demand;
a step of estimating a behavior of an electric vehicle from vehicle information including a past behavior history of the electric vehicle participating in the virtual power plant;
a step of creating a charge-discharge plan of the electric vehicle based on the estimated behavior of the electric vehicle and the power adjustment plan;
a step of instructing the electric vehicle of the charge-discharge plan that is created;
a step of detecting an imbalance of the power supply-demand after instructing the charge-discharge plan to the electric vehicle;
a step of creating a change charge-discharge plan for eliminating the imbalance based on the estimated behavior of the electric vehicle, when the imbalance is detected; and
a step of presenting the change charge-discharge plan that is created to the electric vehicle,
wherein the change charge-discharge plan includes information on an economic merit when the electric vehicle acts in accordance with the change charge-discharge plan and charges and discharges power.
